(19) United States
(12) Patent Application Publication
(10) Pub. No.: US 2022/0044551 A1
(43) Pub. Date: Feb. 10, 2022

(54) SAFETY SYSTEM AND SAFETY APPARATUS

(71) Applicants: Ross David Sheckler, Cato, NY (US); Adam Parker Kovar, Geneva, NY (US)

(72) Inventors: Ross David Sheckler, Cato, NY (US); Adam Parker Kovar, Geneva, NY (US)

(21) Appl. No.: 17/398,680

(22) Filed: Aug. 10, 2021

Related U.S. Application Data
(60) Provisional application No. 63/063,681, filed on Aug. 10, 2020.

(51) Int. Cl. G08G 1/01; G08G 1/0965

(52) U.S. Cl. CPC G08G 1/0112; G08G 1/0965

(57) ABSTRACT

A safety apparatus that obtains sensor input on one or more of inertia, orientation, direction of movement, and location of or associated with a vehicle; provides visual and/or audible alerts; and communicates information regarding the location and/or status of the vehicle to a remote location, such as one or more other vehicles, a service provider, law enforcement, a first responder, or a central server.

### BACKGROUND

Conventional warning systems for a traveler on a roadway are passive devices that require the traveler to be in close proximity to the warning device in order to detect the warning and take action to avoid a hazard. Such passive devices include traffic cones, message boards, sirens, and flares.

In some instances where a hazard is less transient, a more active approach may be employed to alert a traveler to the hazard. An example of such a more active approach is message boards that warn of the hazard, such as an approaching work zone or the site of a vehicle accident, and may also provide information to assist in avoiding the hazard such as the time to the next exit or road intersection. Message boards may also be placed on major highways and used to provide alerts to hazards, such as by weather advisories. These message boards are usually limited to major highways and are not common on smaller/secondary roads.

Navigational application software found on smartphones, or on systems built into vehicles, may have the capability to provide notice of impending hazards on the road, such as objects in the road or construction zones. These applications usually rely on users to report a hazard as they become aware of it. This information is not a reliable, consistent source of accurate information.

The present disclosure relates to a system for communicating a hazard on a roadway to others traveling on or near the roadway prior to them coming upon the hazard, by broadcasting the location and other information about the hazard through wireless communication protocols.

### SUMMARY

The present disclosure in one of its embodiments is directed to a safety apparatus which can be carried by hand, in a pocket, and/or fit into storage spaces in a vehicle. When activated by a traveler, which may be a driver or passenger, the apparatus may provide a visual alert to other drivers and/or vehicles regarding a hazard, such as a vehicle that is stopped on the roadway or otherwise in distress. The apparatus may communicate information about the hazard to, for example, first responders, local law enforcement, local traffic authorities, navigation devices or applications and on-board systems of oncoming vehicles, or a designated location on the internet. The apparatus may use wireless communications; magnetic, gravitational, motion, orientation, and location sensors; and/or user input to determine the location of the apparatus and/or hazard, and the degree of distress in which the vehicle and/or traveler is.

### BRIEF DESCRIPTION OF THE DRAWINGS

FIG. 1 is a view of a safety apparatus in a cylindrical housing.

FIG. 2 is an operational view of a safety apparatus.

FIG. 3 is a view of communication between elements of the safety apparatus.

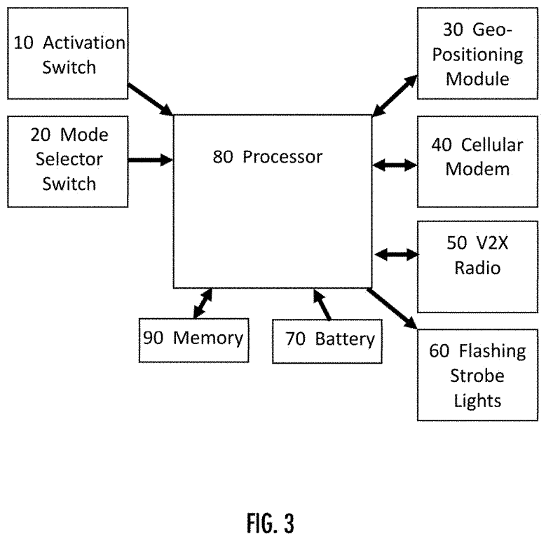

### DETAILED DESCRIPTION

The operation of vehicles on the world's roadways has always included the potential for breakdowns or accidents leaving travelers stranded and possibly in distress. An individual or vehicle stopped on or near a roadway is in danger of being struck by an oncoming vehicle, causing damage as well as potentially serious bodily injuries to the people involved. To decrease the possibility of a stopped vehicle being struck by an oncoming car, visible warning devices such as traffic cones, flares, or strobes have traditionally been placed adjacent to a vehicle that has become stranded.

Drivers are increasingly susceptible to distraction by media, and to relying on on-board navigation systems for turn-by-turn instructions and warnings of hazards such as construction ahead. Drivers are also increasingly relying on automated driving systems, such as advanced cruise control, for certain aspects of the operation of the vehicle. The distractions within the vehicle, and the reliance on audible driving instructions and/or advanced driving systems, may cause drivers to be less aware of events and warnings from the roadway outside the vehicle.

The automotive industry is in the process of transitioning to autonomous systems which rely on data from navigation services via radio or wireless communication protocols such as cellular networks or V2X technologies. Top-tier automobiles currently offered may allow drivers to relinquish the steering, acceleration, and/or braking of the vehicle to automated systems. These systems may be shut off when the vehicle is known to be approaching a hazard such as a work zone or an accident. In some instances, the presence of work zones or other hazards are relayed to the vehicle via navigation services through radio frequency or wireless communication protocols such as cellular networks or V2X technologies. (As used herein, V2X is an umbrella term for vehicle-to-infrastructure and vehicle-to-vehicle wireless communication, including but not limited to WiFi, 4G/4GLTE, 5G/5GLTE, and Dedicated Short-Range Communication (DSRC)).

In the future the occurrence of an accident or other roadway hazard may be reported to the navigation services and added to their databases. Other vehicles approaching a reported accident that are appropriately equipped with wireless communication and certain navigation systems will be able to automatically access the navigation service for the latest hazard information. Vehicles equipped with communication protocols such as V2X may receive signals from similarly equipped vehicles that are involved in, or responding to, the accident. Drivers or automated driving systems will use the information on the location of the accident to react such as by disengaging automation, slowing, seeking an alternative route, and/or maneuvering to avoid the hazard.

This disclosure addresses a gap that may occur between technology that will only exist in more expensive or new-model cars, and vehicles not provided with such technology. This gap is addressed by providing a safety apparatus that can be activated to transmit the presence of a hazard, such as a stopped vehicle, with location information obtained using a global positioning system (“GPS”) or other navigational location protocol to communicate hazard information to other emergency or navigation systems, and/or to other vehicles, via radio or wireless communication protocols, such as V2X or cellular network technologies. The safety apparatus may be used by a driver or passenger in a vehicle to provide information on a hazard observed from that vehicle, or to provide information on a hazard involving the vehicle.

For convenience the safety apparatus is largely discussed herein as a stand-alone apparatus; however, those skilled in the art will appreciate that the functionality of the safety apparatus may be readily integrated into a vehicle electronic and navigation system, or made available in a smart phone through a mobile application that uses the computing platform in the smart phone.

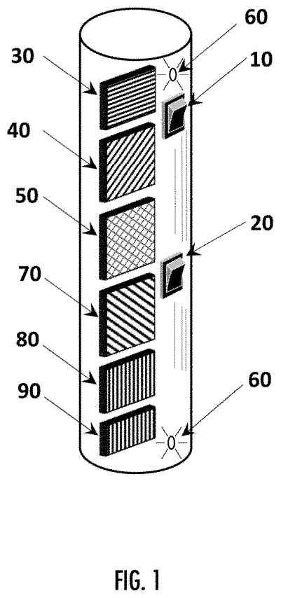

The safety apparatus as depicted in FIG. 1 may include activation module 10 with mode selector module 20 in communication with processor 80. Processor 80 communicates with memory 90, location sensor 30, cellular modem 40, and radio 50, and is powered by battery 70. The safety apparatus may also contain indicator light 60 which may be activated using activation switch 10.

Activation module 10 may activated in any suitable way such as mechanically, as by a switch; by touchscreen; by voice; by detection of a change in location and/or orientation that exceeds a predetermined threshold; or by detection of a change in inertial state that exceeds a predetermined threshold. Activation may therefore occur manually, through user input, or automatically.

When a vehicle is compelled to stop on the roadway, slides off the road, is in an accident, or in some other way is disabled or in distress, a person with the vehicle can activate the safety apparatus by pressing the activation switch 10. Upon activation, the safety apparatus may, depending on mode, activate one or more visual indicators, such as a strobe or strobes, and/or one or more audible indicators, such as a siren; obtain location data through geo positioning module 30; contact a central ‘host’ server 700 with location and/or status data; and/or begin transmitting to nearby vehicles that are equipped with V2X technology. If placed outside the stopped vehicle other drivers may see and/or hear the visual and/or audible alerts, such as flashing strobe 60 and siren 50. Placing the safety apparatus outside the vehicle may also enable it to more efficiently communicate with networks and other vehicles. Even if a vehicle has completely left the roadway and may not be visible to other vehicles, the transmission to networks and to other vehicles still provides the possibility of summoning help.

Activation through pressing the activation switch 10 begins the process of geo-positioning 30 the apparatus and preparing modems and radios 40 and 50 to transmit. The user may be able to select the severity of the event (emergency, send-help, stopped-non-emergency, test) through a selector switch 20.

If the selected condition is ‘test’ lights will flash, the cellular system 680 will send a message to the central ‘host’ server 700 which will send text or email message to the Emergency Contact 720.

When the user selects any mode other than ‘test’ the cellular modem contacts the ‘host’ server, the V2X technology will begin transmitting the standard safety message 600 for a stopped vehicle.

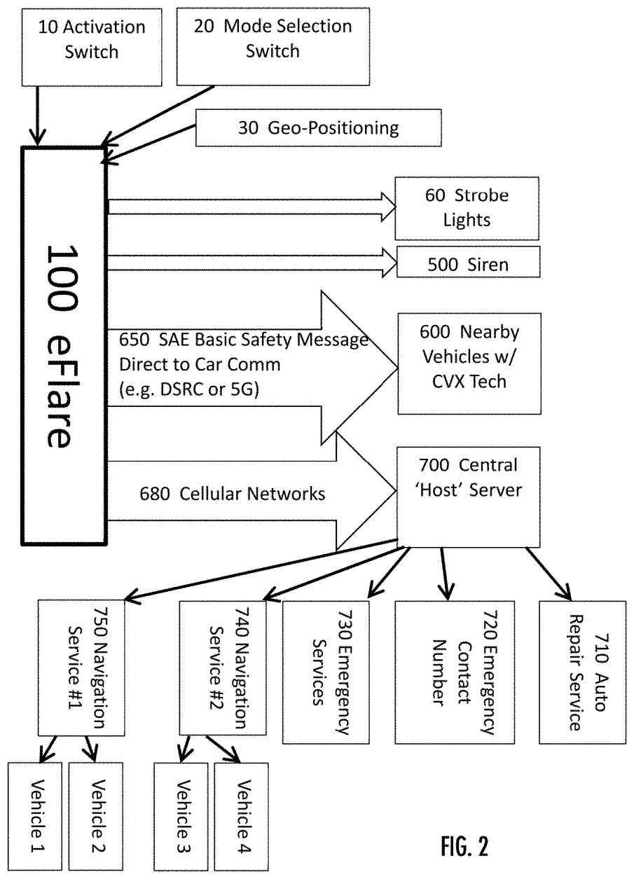

The safety apparatus may have multiple, selectable modes corresponding to the type and/or severity of the alert that the operator may want to convey via the mode selection switch 20, and/or to programmed thresholds that will trigger one or more alerts depending on sensor input. With reference to FIG. 2, it may be that the user desires emergency services to be summoned via Emergency Contact Number 720, and oncoming vehicles must be aware of the hazard created by the stopped vehicle via SAE Basic Safety Message 650. It may be that there is no need for emergency services but mechanical assistance is required and oncoming vehicles must be aware of the hazard created by a stopped vehicle. It may be that the vehicle is merely stopped and does not need assistance, but wants oncoming vehicles to be aware of the hazard created by the stopped vehicle. It may be that the user merely wants to test the apparatus to confirm operation and communication capabilities. By selecting the appropriate mode via the mode selection switch 20 or via software or communication switches that act as a mode selection switch, the safety apparatus may communicate to the host server what service or services should be contacted to aid the stopped vehicle.

More broadly, the safety apparatus may detect at least one of a change in inertia, a change in orientation, a change in direction of movement, and a change in location indicating that the vehicle is in a state that may require assistance. A change in inertia may indicate an impact, such as the vehicle striking or being struck by another vehicle or an object, or may indicate an acceleration or deceleration event of a duration and/or magnitude indicating mechanical and/or operator error or distress. A change in orientation may indicate, for example, that a vehicle has spun or rotated, as in response to wet, icy, or snowy road conditions, of that the vehicle is facing or traveling in the wrong direction on the roadway. A change in direction of movement might, in the absence of location data, indicate that a vehicle is leaving or has left a roadway or a planned route of travel. A change in location might similarly indicated that a vehicle is leaving or has left a roadway or a planned route of travel.

The safety apparatus may be configured to initiate a specific type of alert or alerts based on any or all of a change in inertia, orientation, direction of movement, and location that exceeds a specified threshold. For example, the safety apparatus may detect a change in inertia of the vehicle in which it is located that is indicative of a significant impact, such as striking or being struck by another vehicle or an object, and in response may initiate a request for one or more services such as medical services, towing services, and law enforcement. Similarly, the safety apparatus may detect a change in location indicative of leaving a roadway that does not correspond to a planned route, such as pulling onto a roadway shoulder or median due to mechanical or other difficulties, and initiate a call for services such as towing services. If the safety apparatus detects that the vehicle is traveling in the wrong direction on a roadway, it may initiate an alert to the driver, nearby vehicles, and/or law enforcement. Other appropriate programmed responses to various detection events will be readily apparent.

The present safety apparatus 100 relates to communicating the location and status of a vehicle that is stopped on the side of a highway or otherwise in distress via a range of modes specifically wireless-direct-to-vehicle (V2X) communications 600 or cellular internet communications to rescue and navigation systems 700. The safety apparatus allows operators of all highway vehicles to easily deploy a beacon with technologies that may only exist in luxury vehicles produced after 2020 using the eFlare 100. The safety apparatus provides the means of alerting the operators of oncoming vehicles to the presence of a stranded or otherwise distressed vehicle via radio frequency or wireless protocols such as V2X technology 600 as well as cellular internet links 700 to vehicle navigation systems.

The safety apparatus will use both traditional alerting mechanisms such as strobe lights 60 and perhaps sirens 500 to signal the presence of the traveler or vehicle on the side of the roadway and it will utilize geo-location information obtained from its GPS 30 as well as radio or wireless communication protocols cellular network 680 and V2X technologies 650 to communicate to traveling automobiles its exact location and status. The safety apparatus will send messages via radio or wireless communication protocols such as cellular networks to the entities that provide real-time traffic information for vehicle navigation systems 740 and 750 so that those drivers who are using the navigation systems will be warned of the vehicle/traveler in distress on the road ahead with its exact location and status. The safety apparatus will also utilize peer to peer communication protocol such as V2X technology to transmit a standardized safety message for a stopped vehicle to those vehicles in the region that have V2X technology 600.

As an alternative or in addition to the visual and audible alerts discussed above, the safety apparatus may have the capability of initiating visual and/or audible alerts using the vehicle's integral components. For example the safety apparatus may, if suitably integrated with the vehicle systems by wireless or wired connection, turn on the vehicle's emergency flashing and/or horn functions, similar to the ‘panic’ mode provided on many key fobs.

Based upon the severity of the mode selected the ‘host’ server will populate the data servers of participating Navigation Services 740 and 750 identifying the location as a ‘hazard’ with vehicle stopped. The ‘host’ may also contact Emergency Services 730, Auto Repair Services 710, and possibly send a text message or email to the Emergency Contact 720 with a notice of the event.

When the activation switch 10 is turned off the safety apparatus terminates the V2X transmissions and sends a termination message to the ‘host’ server 700 via the cellular modem 40.

While the present safety apparatus and system have been described with reference to particular embodiments, it will be understood by those skilled in the art that various changes may be made and equivalents may be substituted for elements thereof without departing from the intended scope. In addition, many modifications may be made to adapt these teachings to a particular situation or use environment without departing from the intended scope.

Therefore, it is intended that the scope not be limited to the particular embodiments disclosed herein, but rather will include all embodiments falling within the scope and spirit of the appended claims.

We claim:

1. A safety apparatus for association with a vehicle, said safety apparatus comprising:
a) an activation module;
b) a mode selector module;
c) a processor;
d) memory;
e) at least one sensor; and
f) at least one wireless communication module,
wherein said at least one sensor is in communication with said processor and is a location sensor, an inertia sensor, a direction sensor, or an orientation sensor, further wherein said activation module is configured, upon activation, to perform at least one of
g) activating a visual alert,
h) activating an audible alert, and
i) using said wireless communication module to send data regarding the status of the vehicle to a remote location.

2. The safety apparatus of claim 1 wherein said activation module is configured for manual activation.

3. The safety apparatus of claim 1 wherein said activation module is configured for activation through user input.

4. The safety apparatus of claim 3, further wherein said user input comprises at least one of a touchscreen and voice input.

5. The safety apparatus of claim 1 wherein said mode selector module is operable to select, upon activation of said safety apparatus, at least one of:
a. a test of said safety apparatus,
b. activation of a visual indicator,
c. activation of an audible indicator,
d. activation of a request for emergency services,
e. activation of a request for mechanical assistance,
f. activation of an alert to a driver of the vehicle,
g. activation of an alert to nearby vehicles,
h. obtention of location data,
i. transmission of location data, and
j. contact with a host server.

6. The safety apparatus of claim 1 wherein said activation module is configured for automatic activation in response to data from said at least one sensor exceeding a predetermined threshold.

7. The safety apparatus of claim 1 wherein said at least one wireless communication module comprises at least one of a WiFi module and a V2X module.

8. The safety apparatus of claim 1 wherein said wireless communication module comprises a V2X module, further wherein said V2X module comprises at least one of a 4G, 4GLTE, 5G, and 5GLTE module.

9. The safety apparatus of claim 7 wherein said wireless communication module comprises a V2X module, further wherein said V2X module comprises a Dedicated Short-Range Communication module.

10. The safety apparatus of claim 1 wherein said activation module is configured, upon activation, to activate a visual alert, further wherein said visual alert comprises at least one of the vehicle's emergency flashers and a strobe.

11. The safety apparatus of claim 1 wherein said activation module is configured, upon activation, to activate an audible alert, further wherein said audible alert comprises at least one of the vehicle's horn and a siren.

12. The safety apparatus of claim 1 wherein said safety apparatus is configured to initiate a request for at least one of medical services, towing services, and law enforcement in response to said at least one sensor detecting a change in inertia exceeding a predetermined threshold.

13. The safety apparatus of claim 1 wherein said safety apparatus activated by said at least one sensor providing an indication of a change in location that does not correspond to a planned route.

14. A safety apparatus integrated into a vehicle electronic and navigation system, said safety apparatus comprising:
j) an activation module;
k) a mode selector module;
l) a processor;
m) memory;
n) at least one sensor; and
o) at least one wireless communication module,
wherein said at least one sensor is in communication with said processor and is a location sensor, an inertia sensor, a direction sensor, or an orientation sensor, further wherein said activation module is configured, upon activation, to perform at least one of
p) activating a visual alert,
q) activating an audible alert, and
r) using said wireless communication module to send data regarding the status of the vehicle to a remote location.

15. The safety apparatus of claim 14 wherein said activation module is configured for manual activation.

16. The safety apparatus of claim 14 wherein said activation module is configured for activation through user input.

17. The safety apparatus of claim 16, further wherein said user input comprises at least one of a touchscreen and voice input.

18. The safety apparatus of claim 14 wherein said mode selector module is operable to select, upon activation of said safety apparatus, at least one of:
a. a test of said safety apparatus,
b. activation of a visual indicator,
c. activation of an audible indicator,
d. activation of a request for emergency services,
e. activation of a request for mechanical assistance,
f. activation of an alert to a driver of the vehicle,
g. activation of an alert to nearby vehicles,
h. obtention of location data,
i. transmission of location data, and
j. contact with a host server.

19. The safety apparatus of claim 14 wherein said activation module is configured for automatic activation in response to data from said at least one sensor exceeding a predetermined threshold.

20. A vehicle comprising a safety apparatus, said safety apparatus comprising:
a) an activation module;
b) a mode selector module;
c) a processor;
d) memory;
e) at least one sensor; and
f) at least one wireless communication module,
wherein said at least one sensor is in communication with said processor and is a location sensor, an inertia sensor, a direction sensor, or an orientation sensor, further wherein said activation module is configured, upon activation, to perform at least one of
a) activating a visual alert,
b) activating an audible alert, and
c) using said wireless communication module to send data regarding the status of the vehicle to a remote location.
